(19) United States
(12) Patent Application Publication
(10) Pub. No.: US 2015/0134353 A1
(43) Pub. Date: May 14, 2015

(54) HEALTH CARE SERVICES OPTIMIZATION PLATFORM, STRATEGIC PURCHASING & METHOD RELATED THEREOF

(71) Applicants: Karen Elaine Ferrell, Alpharetta, GA (US); Bradley Alan Keywell, Glencoe, IL (US); Lee Allan Shapiro, Wilmette, IL (US); Glen Edward Tullman, Wilmette, IL (US)

(72) Inventors: Karen Elaine Ferrell, Alpharetta, GA (US); Bradley Alan Keywell, Glencoe, IL (US); Lee Allan Shapiro, Wilmette, IL (US); Glen Edward Tullman, Wilmette, IL (US)

(21) Appl. No.: 14/539,703

(22) Filed: Nov. 12, 2014

Related U.S. Application Data
(60) Provisional application No. 61/903,271, filed on Nov. 12, 2013.

(51) Int. Cl. G06F 19/00; G06Q 10/10; G06Q 30/06

(52) U.S. Cl. CPC G06F 19/3406; G06Q 30/0623; G06F 19/3418; G06Q 10/1095
USPC 705/2

(57) ABSTRACT

The present invention relates to a digital medical interface to help streamline the overall health care service provider experience by patients seeking care, negotiating costs associated with the care and paying for the services. The invention more specifically relates to a web-based/app-based software interface for a very unique combination of collection, display and use of medical treatment-related information using different remote devices and different databases of information. Further, the invention covers methods for reducing health care costs, including steering patients to appropriate low-cost alternatives and reducing the number of unnecessary procedures by providing patients with live guidance from a personal health care professional, implementing strategic buying procedures, reducing administrative overhead and making guaranteed payments to providers at the time of service, and guiding patients to appropriate preventive procedures based on factors such as their personal health risk assessment and prior claims history.

### CLAIM OF PRIORITY

The present is a non-provisional utility patent application which claims priority from and the benefit of provisional utility U.S. Patent Application No. 61/903,271, filed Nov. 12, 2013, entitled HEALTH CARE SERVICES OPTIMIZATION PLATFORM & METHOD OF USE THEREOF, which application is hereby incorporated herein fully by reference.

### FIELD OF THE INVENTION

The present invention relates to a digital medical interface designed to help streamline the overall health care service provider experience of patients seeking new or regular care, negotiating costs associated with the care and paying for the services. The invention more specifically relates to a web-based/app-based software interface for a very unique combination of collection, display and use of medical treatment-related information using different remote devices and different databases of information. The software offers a single interface for contacting providers, scheduling appointments, performing initial diagnoses and accessing health-related information.

### BACKGROUND

Health care services are unlike most other services offered or purchased regularly by consumers in the United States. These services are amongst the most complex to understand and navigate once they are needed. In most of the potential interactions in this industry between a service recipient (e.g., a patient) and a service provider (e.g., a doctor), multiple third parties, with different interests, play different roles. These third parties include, for example, private insurance providers, the U.S. government, owners of service facilities such as hospitals and nursing homes, ambulance services providers, pharmacies, nurses, specialty care, etc.

Too often, health care services fall must be acquired or used in times of crisis and urgently. Also, at the heart of health care service industry are two important dimensions, the quality of the service and the affordability of the care. Since it is often difficult to know, from a distance if the medical advice is good, patents will often have to rely on other quality related factors to make informed decisions. These factors can include the proximity and availability of these services, the capacity to select a specific doctor, the type and level of technology at the treatment facility, the nature of follow-up care, and opinions of third parties on improved condition resulting from the care. Since patients rarely pay for the totality of the health care, the affordability of the care includes factors such as the accessibility to comprehensive coverage, and the capacity to anticipate costs and deductible payments, and make informed decisions as to level of reimbursement.

To help understand the scope and importance of the current invention, it is important to provide the reader with a baseline description of relevant portions of the current existing system. Health care services generally lack transparency and market-based pricing. Patients are typically not able to shop for the lowest-priced services from one health care provider to the next even if they reside in a city with two or health care institutions offering the same service. A patient will contact a first doctor who will prescribe treatment options, and too often the patient will follow the instructions. According to a study conducted by the California Healthcare Foundation, only 25% of visitors asking for pricing information upon an initial visit to a hospital were informed as to the price of these services. Visitors and patients rarely have a clear financial incentive to negotiate costs at the time of service, believing all providers offer the same services for the same costs and relying on the insurance provider to pay for most of the service.

A large majority of Americans currently hold some type of health insurance (up to 85%, according to some studies). With the enactment of the Affordable Care Act, new exchanges are available to individuals and hopefully this rate is likely to increase over the next years. But while exchanges help patients understand some of the terms of their insurance, they rarely pay directly for the services. They secure the services and a bill is sent at a later date. They then discover that some type of deductible applies and that some of the costs are not covered by the insurance. For costs that ultimately will be covered by insurance, patients do not care about the costs billed by the hospital.

In the United States, each health care service provider, such as a hospital, uses what is known as a “chargemaster,” a/k/a a charge description master (CDM), as a comprehensive listing of items billable to a patient or to a patient's health insurance provider. The CDM serves as the starting point for negotiations with patients and insurance providers as to how much money will be paid for any given service.

The CDM is often found as some type of extremely large master file, written in such a way that only few hospital administrators are capable of deciphering it. Patients and doctors alike are then unable to understand these charges and cannot compare them and shop for lower-cost services. Doctors at a health care facility will often be unable to truly anticipate the cost of services they offer.

The CDM is also designed to interface with very unique and specified government-mandated standardized billing systems. The CDM includes costs as varied as hospital services, medical procedures, equipment fees, drugs, supplies, tests, imaging fees and diagnostic evaluations. Each item in the CDM is assigned a unique identifier code that is used to generate bills. The CDM is central to the payment and fees charged by the health care service provider and is closely monitored and reviewed by the different parties, often as often as on a yearly basis.

According to the essentials of managed health care, the CDM typically includes over 5,000 price definitions. Only California requires posting of the CDM, and Maryland is the only state to regulate the CDM itself. The price charged in the charge master of each hospital is internal and set by the facility itself. Although Medicare and Medicaid do not base their payment rates on the CDM figures, private health insurance companies typically do. As a consequence, private insurance typically pays more than the government does for the same services. This translates to higher premiums for insured individuals, as an insurer will often not know where a patient will ultimately receive services and what level of payment will be required. Commentators, politicians, journalists, and health care industry experts openly criticize the opaqueness of the CDM system and argue that each facility does not base charges on the reality of the costs of the services offered and often will inflate costs based on multiple illogical external parameters.

Since the government pays for the cost of services for Medicare or Medicaid recipients, and private insurance companies pay for the cost of services for anyone who is insured, only the uninsured, often people who have limited resources, are expected to pay the full CDM price. In May 2013, a massive federal database of national health care costs was made public for the prices requested by the service providers. The data reveals that prices for the same services varied greatly from one facility to the next. In the New York area alone, a first hospital center in New Jersey charged $99,690 for treating chronic obstructive pulmonary disease (COPD), compared to $7,044 per patient for a second center in the Bronx.

The publication of the data was designed to offer transparencies in the hope that some of these disparities in prices would slowly subside based on corrective market forces. These forces simply do not exist today. In the United States, medical service providers set their prices in ways that often may appear arbitrary, with little oversight and practically no market incentive to reduce the prices, since few patients ever pay the official rates. According to a report issued in June 2012 by the Medicare Payment Advisory Commission, an expert panel to Congress, while in 1999, average charges billed to Medicare were equal to 104 percent of the cost to provide medical care, by 2010, the ratio had more than double to 218 percent.

Medicare and Medicaid are managed at the federal level by the Centers for Medicare and Medicaid Services (CMS). CMS sets fee schedules for medical services through the Prospective Payment System (PPS) for inpatient care, outpatient care and other services. This system has a significant impact on the market. Part of this system relies on Relative Value Units (RVUs) assigned to each medical procedure. Each RVU translates into a dollar value that varies by region and by year. In 2005, the RVU (not adjusted for location) was $37.90. The major insurers, in an effort to draw down the prices of the CDM, negotiate payment schedules using the RVUs or, better yet, using the Medicare payment schedule. Over the years, to keep costs down in the health care area, pressure has been placed on the RVUs to remain low, creating a wider difference between these costs and the full CDM prices.

CMS uses Level 1 of the Health Care Procedure Coding System (HCPCS), which in turn relies on the American Medical Association's Current Procedural Terminology (CPT), which is issued and revised annually. These codes are broken down into several categories, and the first Category I CPT Code(s) is in turn broken down into six main sections: (a) Evaluation and Management [99201-99499], (b) Anesthesia [00100-01999; 99100-99150], (c) Surgery [10021-69990], (d) Radiology [70010-79999], (e) Pathology & Laboratory [80047-89398], and (f) Medicine[90281-99099; 99151-99199; 99500-99607]. The use of these codes quickly becomes very complex, as most services include different components that are found in several of the different sections. For example, the visit of a patient to a family doctor because of hay fever includes an office outpatient service (section (a) Evaluation), the diagnosis and performance of allergy services (section (f) Medicine), etc. Bills issued using the CMS and relying on the CPT or even the CDM are, as these numerous acronyms suggest, extremely confusing to individuals.

Under the Federal Emergency Medical Treatment and Labor Act (EMTALA), all Medicare-participating hospitals with emergency departments must provide stabilizing care to patients with an emergency condition, regardless of the patient's ability to pay. While a hospital can send bills for the totality of the services it provides, it must send bills to Medicare/Medicaid at a fixed rate and will bill private insurers at a higher rate to compensate for the 5-10% of paid for care to poor and/or uninsured patients that ultimately will be paid for by an increase of charges to private insurance patients.

Bills sent by service providers for the same services can vary widely based on how the services are described by the different physicians using CPT codes and how the CDM describes the services and incorporates the CPT codes. The same bills also will be tailored to private insurers, Medicaid, or uninsured individuals. Finally, as private insurance providers are able to deny or pay only portions of services based on their contractual relationship with the insured or the lack of preapproval for the services provided, these insureds will often receive partial invoices for deductibles and be only partly reimbursed for services.

Today, an individual's decision to initiate medical-related services is unique in many aspects. Some services happen after the confluence of extraordinary circumstances (e.g., a patient lands in an emergency room after an accident), leaving a patient little to no time to negotiate rates or make a decision regarding the service provided. In other conditions, the services are planned after an early diagnosis and encounter with a physician or other medical professional. These diagnosed conditions may result in a decision to negotiate further services or seek treatment (i.e., cancer treatment and a second diagnosis). In this condition, an individual may be able to get involved and learn of the different elements associated with the care and the associated payments.

Finally, other conditions of care are partly or purely elective (e.g., cosmetic surgery or weight loss surgery) and will center around the ultimate cost to a patient and the capacity to secure private funding or obtain precertification from a health care insurer. In each of these options, a patient's right and privilege to select his/her physician and the location of treatment is always one of the main considerations.

Some statistics show that over 80% of individuals filing for bankruptcy do so because of health-related expenses. Few people petition insurance companies for preapproval of procedures, and even these preapprovals can result in unexpected uncovered portions. The preapproval process is difficult, long, and often in discordance with the actual bill issued by the health care provider. An insurer may preapprove two doctor visits for a condition, but when a doctor visits the patient four times and these frequent visits are reflected on the bill, the patient even with preapproval will be left to pay the difference. Further, doctors are often the parties who understand the nature of the services to be provided and will reach out to seek preapproval.

Comprehensive health insurance pays a percentage of the cost of hospital and physician charges after a deductible or a co-pay to be paid by the insurance company. Even when a patient has employer coverage, understanding what is covered and what is not is often difficult. The coverage of the different treatment options available to a patient may differ widely. For example, a patient diagnosed with cancer may be given different options. A doctor may offer three solutions, each with a different probability of success, with a warning that not all insurances will cover certain newer and more-expensive treatment solutions.

In this example, with the current system, a patient is then left with the difficult task of having to manage immediately after having received a severe life-threatening diagnosis, the need to factor in the different alternatives on his/her life expectancy while at the same time having to investigate with an insurance company if the option is covered or what portion is covered.

The breadth of coverage of individuals in the United States associated with the numerous options can be mind boggling. Public health care coverage includes Medicare Advantage and Medicare Part D, Medicaid, State Children's Health Insurance Programs (SCHIPs), military health benefits, state risk pools, Indian health services, and pre-existing condition insurance plans. Private health care coverage include four types of employer-sponsored coverage (small employer group coverage, college-sponsored health insurance for students, the federal employees health benefit (FEHB) plan, and portability of group coverage); private health care also includes association group health coverage and individually purchased coverage of multiple types, including on newly established markets. Today, new plans being made available on the exchanges for the uninsured also have varied levels of coverage and complexity.

Very often, an individual even if insured will have a very limited understanding of his/her own coverage. Some insurances and some services require preapproval, also known as precertification. These include some health care services, such as surgery or hospital visits. Very often, a doctor will contact the insurer directly prior to dispensing care, but this process from a third party to the insurance company will not result in the optimal means to force coverage of procedures. A physician who learns that the insurance company will not approve a test but who strongly believes the test is necessary may force a patient to undergo the test, resulting in fees being billed to the patient.

For example, Independence Blue Cross (IBC) requires preapproval/precertification for multiple services. A patient can use either a phone number (1-800-ASK-BLUE) or a web portal named VaviNet® to submit requests. Even for an employer plan, the list of services and goods that require precertification is rather long. At IBC, these include inpatient services, outpatient services, office services, medical equipment, reconstructive procedures, cosmetic procedures, nursing, home-care services, prosthetics and orthotics, mental health issues, and two pages of specialty drugs requiring precertification.

Simply stated, the overall system does not give any of the parties involved an incentive to streamline the process, optimize costs and offer the best services. Interests of the different parties diverge greatly in this current scenario. Health care providers, which are generally for-profit corporate entities, desire to maximize their profits to shareholders, attract the best talent and the best equipment, and provide the best level of service by raising their prices and lowering their costs of purchasing the different equipment, drugs and implants. Forced by law to treat those without insurance coverage, as well as those who are insured but are unlikely to pay uncovered portions, they raise basic prices and try to negotiate the highest rates possible with the insurance providers.

Insurance providers are also incentivized to increase profits to shareholders by raising the price of premiums, increasing deductibles and denying as much care as legally possible. To increase profits, insurance companies push health care facilities to draw down their prices and to cut down on what they consider over-precautionary tests and medical procedures by denying payments to beneficiaries. Insurance service providers indirectly benefit from higher health care service prices as they create pressure on the uninsured to seek and obtain medical insurance.

Finally, the real party with the incentive to benefit from low service prices and low health care insurance premiums is often overwhelmed by a complex multiparty system. Obtaining quotes and negotiating health care service prices, seeking preapproval and making sure insurance coverage aligns with expectations is almost impossible to all but the professionals.

What is needed is a new platform and an associated system to help consumers to understand the health care system, negotiate and secure reliable preapprovals, anticipate costs and pay for legitimate services received from providers.

### SUMMARY

The present invention relates to a digital medical interface to help streamline the overall health care service provider experience by patients seeking care, negotiating costs associated with the care and paying for the services. The invention more specifically relates to the management of treatment of patients and the software and method of use thereof, more particularly a web-based/app-based software interface for a very unique combination of collection, display and use of medical treatment-related information using different remote devices and different databases of information.

More specifically, the invention is directed at a software application and method for optimizing the patient experience with health care by providing a single interface for contacting providers, scheduling appointments, performing initial diagnoses and accessing health-related information. Further, it includes methods for reducing health care costs, including steering patients to appropriate low-cost alternatives and reducing the number of unnecessary procedures by providing patients with live guidance from a personal health care professional; implementing strategic buying procedures (with savings generated through bulk purchases); reducing administrative overhead and making guaranteed payments to providers at the time of service; and guiding patients to appropriate preventive procedures based on factors such as their personal health risk assessment and prior claims history. Also presented is a method for streamlining the payment process for health care procedures by providing a personal health care professional to interact with and guide the patient, automatically schedule appointments with providers and patients, verify eligibility for procedures in advance, and make payment to the provider at the time of service.

### BRIEF DESCRIPTION OF THE DRAWINGS

Certain embodiments are shown in the drawings. However, it is understood that the present disclosure is not limited to the arrangements and instrumentalities shown in the attached drawings.

FIG. 1 illustrates the different actors involved the procurement and use of health care insurance according to an embodiment of the present disclosure.

FIG. 2 is an illustration of the hardware associated with the system described at FIG. 1 according to an embodiment of the present disclosure.

FIG. 3 is an illustration of one possible software layer to be used in the hardware shown at FIG. 2 to implement the system shown at FIG. 1.

FIG. 4 is an illustration of the different communication protocols associated with the software at FIG. 3 that also illustrates the different protection protocols according to an embodiment of the present disclosure.

FIG. 5 is a graph illustrating cost-saving reductions contemplated by the use of this invention according to an embodiment of the present disclosure.

FIG. 6 is a diagrammatic representation of the different actors using the system of the current invention according to an embodiment of the present disclosure.

FIG. 7 is a screen shot of the four main elements of the new software system according to an embodiment of the present disclosure.

FIG. 8 is a screen shot of the first of the four elements shown at FIG. 7 according to an embodiment of the present disclosure.

FIG. 9 is a screen shot of the fourth of the four elements shown at FIG. 7 according to an embodiment of the present disclosure.

FIG. 10 is a screen shot of the second of the four elements shown at FIG. 7 according to an embodiment of the present disclosure.

FIG. 11 is a screen shot of the third of the four elements shown at FIG. 7 according to an embodiment of the present disclosure.

FIG. 12 is a diagram representing the strategy purchasing method according to an embodiment of the present disclosure.

FIGS. 13A to 13C represent three screen shots highlighting an advertising and notice area as part of a software display according to an embodiment of the present disclosure.

FIG. 14 is a screen shot of an app software display of the health care services optimization platform showing the “talk to me” element according to an embodiment of the present disclosure.

FIGS. 15A to 15H are multiple screen shots of an app software display of the health care services optimization platform showing the “evaluate me” element according to an embodiment of the present disclosure.

FIGS. 16A-16C are multiple screen shots of an app software display of the health care services optimization platform showing the “inform me” element according to an embodiment of the present disclosure.

FIGS. 17A-17F and 18A-18H are multiple screen shots of an app software display of the health care services optimization platform showing the “schedule me” element according to an embodiment of the present disclosure.

FIG. 19 is a screen shot of an app software display of the health care services optimization platform showing the reward points system according to an embodiment of the present disclosure.

FIGS. 20A and 20B are multiple screen shots of an app software display of the health care services optimization platform showing the “my profile” element according to an embodiment of the present disclosure.

FIGS. 21 and 22 illustrates the steps of a method for providing optimized health care services over a health care services optimization platform.

FIG. 23 illustrates the steps of a method for allowing strategic purchasing from supply vendors by a service facility using an optimized health care services optimization platform.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

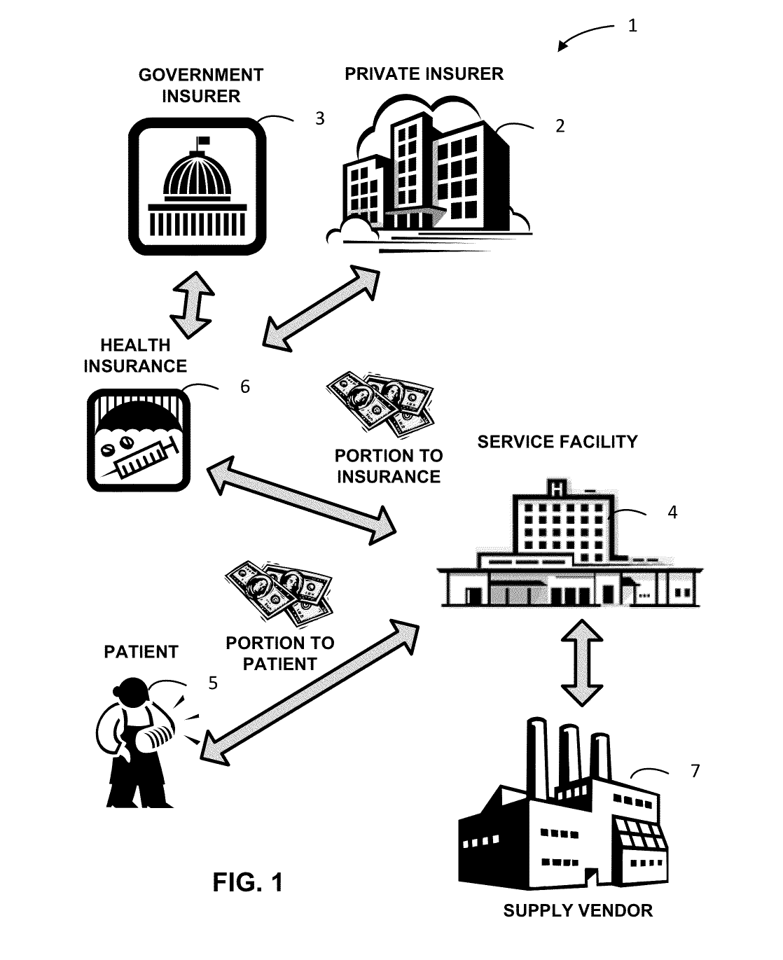

FIG. 1 illustrates from a distance part of the interactions in the highly complex overall process associated with the acquisition of health care services in the United States. In the health care process 1, a patient 5 having a need for medical services (illustrated here by a patient with cast) will seek to receive the services at one of multiple different service facilities 4, such as for example a hospital, a nursing home, a pharmacy, an ambulance or any other facility at which any type of health care-related services and associated goods can be offered. These facilities 4, in addition to providing services that in turn require goods, can also offer goods such as equipment, drugs, implants and other medical service-related goods to treat the patient 5. These goods are often supplied by a supply vendor 7. As shown at FIG. 1, a patient 5 may pay a portion of the costs directly to the service facility 4, or he or she may rely on health insurance 6 to pay a portion of the costs. The insurance 6 can be provided by multiple sources, including for example private insurers 2 or government insurers 3. Because of the importance of health care and the sheer volume of services offered each year, one of ordinary skill in the art will understand that each of these different elements shown at FIG. 1 describes each of these concepts with a high level of abstraction.

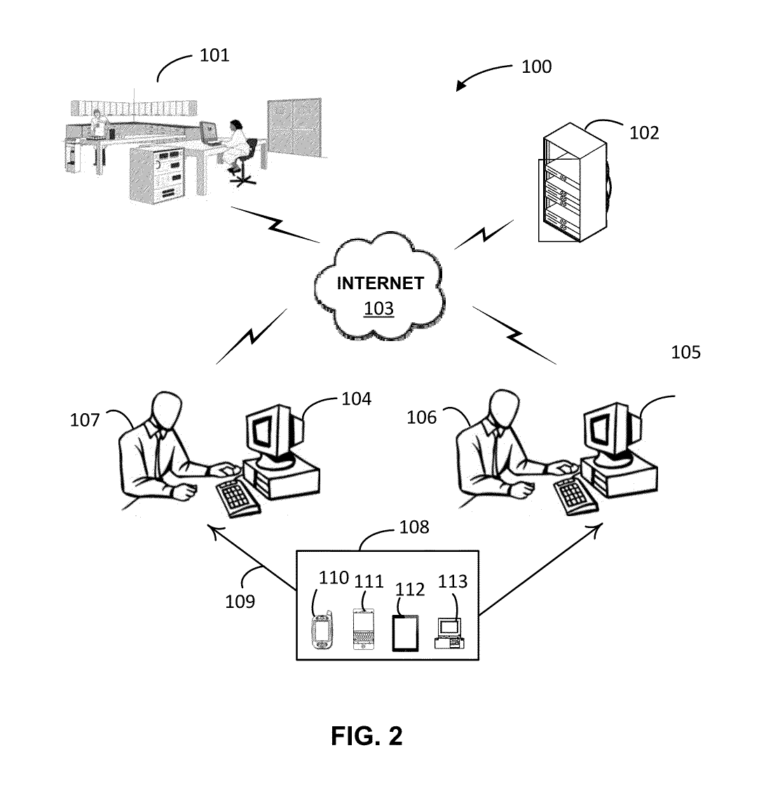

To implement the transfer of services and associated transfer of resources, what is used in the current invention is a fully automated or partly automated system 100 as shown at FIG. 2. FIG. 2 shows generally how in today's environment multiple parties 106, 107 can use computer stations 104, 105 equipped with a display, a user interface and a processor unit connected to a memory to execute software for use by the parties. As shown, these parties 106, 107 are now capable of using 109 portable devices 108 instead of a computer station 104, 105, for example handheld devices 110, 111, 112, 113 having transceivers to connect to wireless networks, or transceivers to connect via web servers to the Internet 103 or any other network. Generally, multiple different systems will be connected directly or indirectly to the parties' software, for example on a server 102. Different users 101 will then be able to connect remotely via the Internet 103 or other network communication systems to the different parties. The structure shown at FIG. 2 is illustrative only generally of the technology layer in the form of hardware used by the different parties, for example the parties at FIG. 1. As shown in this figure, an app store at which, for example, software apps can be purchased may be illustrated by the server 102.

One of ordinary skill in the art will understand that each of the government insurer 3, the private insurer 2, the service facility 4, the supply vendor 7 and the patient 5 shown at FIG. 1 may be equipped with some of the hardware illustrated at FIG. 2 as part of the process of acquiring health insurance 6, the process of payment and the process of securing services.

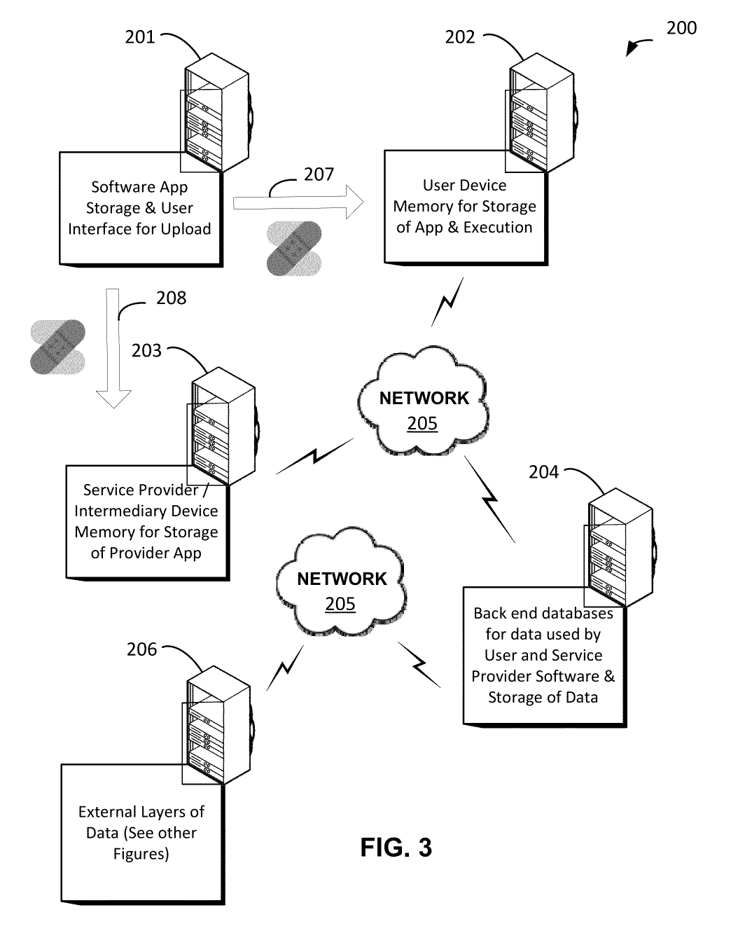

FIG. 3 illustrates one possible software layer made of multiple interlaced applications and layers of software found in servers and other types of hardware, for example the structure shown at FIG. 2 for services such as those described at FIG. 1. In the overall software system 200, a stand-alone executable program, such as an program in app format (called an app) is uploaded into a storage server 201, for example an app store. Users will then access the store on the server using the network 205 and receive via the normal interface either a user device version 207 or a service provider version 208 based on the type of party uploading the app from the server 201. In one embodiment, a single version of the app can be produced for upload irrespective of the type of party (user or service provider). The app is then stored on the memory of the storage device used by the user 202 and the memory of the service provider device 203. For example, a doctor and a nurse can upload the app from the app store 201 onto their own handheld devices 203. A patient can also upload the app from the store 201 into a handheld device 202 for access. As shown by the arrows around the network 205, the users and the service providers can then be connected to each other via the network, using the app as executed in the software layer of each device.

What is not shown is the computer software and hardware needed to create and upload the app to the app store 201. As with most Apps, once the software is made to execute, it can require either a regular data connection, regular updates or a live constant data connection with a back-end database that stores and makes the data available to the apps. The back-end server 204 can use any type of server and database commercially available on the market, for example an Oracle database. Data will then be exchanged between the different devices 201, 202, 203, and 204 using regular port technology, transceivers, wireless or non-wireless technology, and for example different HTML/API tools and layers to help with interface and communication of data. For example, the app of multiple users 202 may be programmed so at any moment at which a nurse or a doctor contact is initiated, the app will connect with the back-end database 204 and/or the status of the multiple service providers 203 to determine which link and connection should be immediately established or programmed for appointment. The data sent back to the doctor 203 may include client medical information and other relevant information. As the doctor and the patient use the network 205 to communicate, the doctor may use the software to help generate needed information from the database 204 or to get information about the user 202 from his/her device. While one structure of data communication is described, what is contemplated is the use of multiple devices, each with one or multiple versions of an app used and designed to exchange information together or with a back-end server.

Finally, FIG. 3 shows how other, generally remote external layers of data and information 206 can be connected to the system over the network 205. For example, in a case in which a physician's software layer 203 is engaged in a one-to-one communication with a patient's device software layer 202, the physician may have a need to schedule an appointment and reserve a X-ray room at his/her practice. Since the schedule of the room of his/her hospital is located on the server of the hospital and may not be found on the back-end database servicing the app directly, either the app in the physician's layer 203 can communicate via the network 205 with the hospital 206 and the appropriate database, or the back-end server 204 can be enabled to do so 206. The access of the different databases and their interconnections will be described hereafter.

The current disclosure relates to a system, software and hardware enabled in software that functions either in a new software layer or as pages of HTML format or other format in a browser of network information such as Internet information. This system is at the heart of a global, fully integrated platform in which patients (i.e., clients) can be connected directly with their doctors (users) as shown at FIG. 2. The system 100 relies generally on the Internet 103, where several elements 101, 102, 104 and 105 are connected. For example, in one embodiment, a user 105 using a fixed terminal 113, a portable tablet 112, a web-enabled phone 111 or a WAP-enabled phone 110 or any other device 108 to communicate with a patient 107 who is also using a device 104 such as a fixed terminal 113, a portable table 112, a web-enabled phone 111 or a WAP-enabled phone 110 or any other device 108.

The patient 107 communicates via software over the Internet 103 with a doctor 106 or any other medical service provider. As shown at FIG. 2, data can be used and merged into the system and software from different databases 102, each connected to the Internet directly or indirectly, or laboratories or service providers 101 as shown. One of ordinary skill in the art will recognize that while one configuration of use is shown, what is contemplated is any configuration.

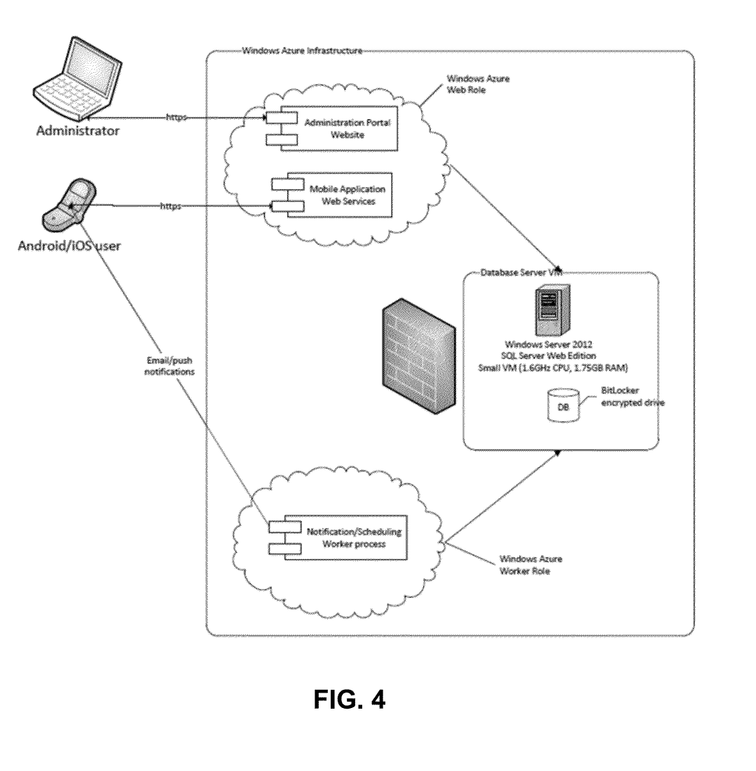

FIG. 4 is an illustration of the different communication protocols associated with the software at FIG. 3 that also illustrates the different protection protocols according to an embodiment of the present disclosure. An administrator can use a portable computer and, using a first protocol such as HTTPS, can access a Windows® Azure® infrastructure. Within the infrastructure shown by the square line, either the administrator or a user of a portable station using an Android® or iOS® operating system can also connect within the infrastructure using HTTPS protocol or push/email a notification within the infrastructure.

In one embodiment, a Database Server VM, for example Windows® Server 2012 SQL Server Web Edition, connects to a bitlocker encrypted drive to create worker roles and web roles to help implement worker processes, administration portals, mobile application web services, etc. As shown, the use of encryption and heightened security is highly desirable because of the nature of the field, as personal and identifiable information of a medical nature is highly regulated. One of ordinary skill in the art will recognize that most of the software layers and hardware described comes with different levels of security and that this security, including but not limited to passwords, is contemplative of use.

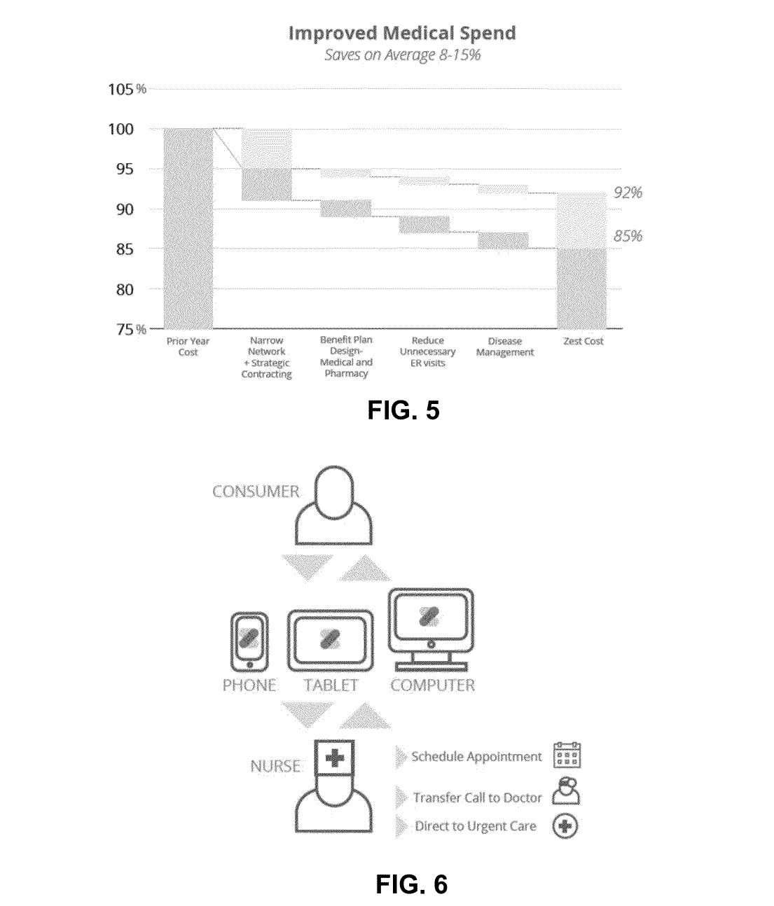

FIG. 5 is a graph illustrating cost-saving reductions contemplated by the use of this invention according to an embodiment of the present disclosure. As shown, savings in health care costs can come from multiple different avenues, including narrow network and strategy contracting, benefit plan design, reduction of unnecessary emergency-room visits and disease management. By implementing all these different solutions simultaneously, cost savings can reach 8 to 15% nationwide.

FIG. 6 is a diagrammatic representation of the different actors using the system of the current invention according to an embodiment of the present disclosure. As shown above, a consumer in need of medical services, using one of multiple devices including a phone, a tablet or a computer, can contact a health care professional for triage, for example a nurse as shown to help schedule an appointment, transfer the call to a doctor, or direct to urgent care.

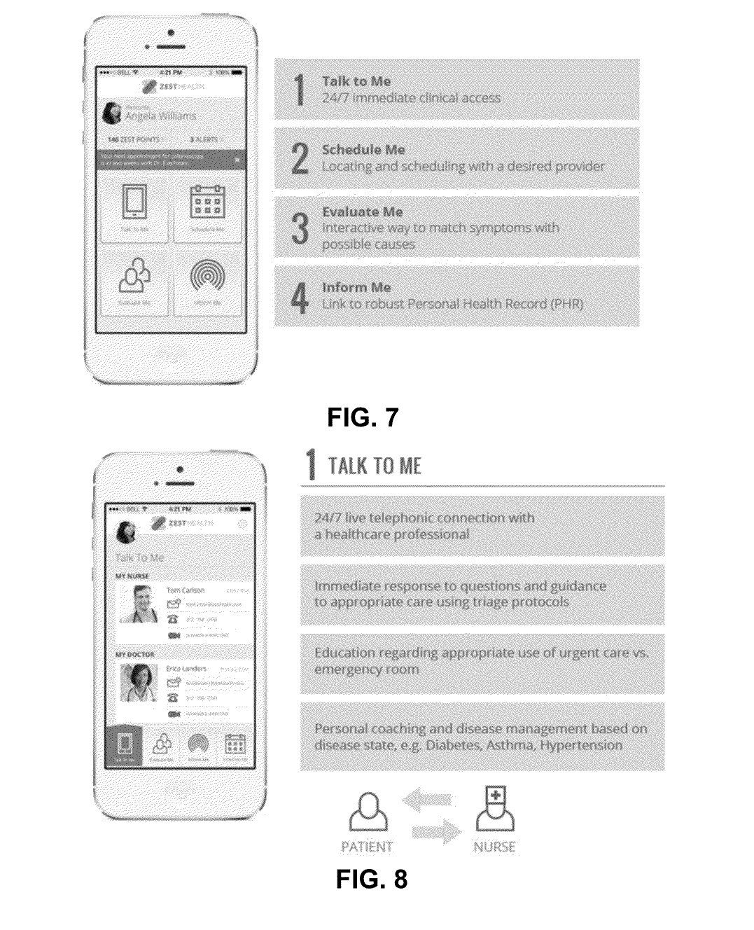

FIG. 7 is a screen shot of the four main elements of the new software system according to an embodiment of the present disclosure. This figure shows how a small app or any other type of software interface as described above can join several user specific-tools to help create a seamless and transparent health care service that enhances the overall experience, creates costs savings and helps a user implement new technology in a service historically reserved to live consultations and phone contacts. For example, the tool can include a “talk to me” button 301 for 24/7 immediate clinical access, a “schedule me” button 302 to locate and schedule a contact with a service provider, an “evaluate me” interactive interface 303 to help find and match symptoms and possible causes to help with the overall process, and an “inform me” button 304 to help link to robust databases to help a person acquire and secure robust Personal Health Records (PHR). Also as shown, a picture of the user along with the name of the user can be displayed to help a user understand that the interface is personal. As shown, alerts and award points can be used to further incentivize a user.

FIG. 8 is a screen shot of the first of the four elements 301 shown at FIG. 7 according to an embodiment of the present disclosure. Once a user touches the “talk to me” button 301, the interface as shown illustrates and guides the user by placing buttons. This function includes a 24/7 telephonic connection with a health care professional, for example a nurse 401 or a doctor 402 using the phone's normal communication line. This feature is enabled, for example, using the voice transceiver of the device over a network through which phone communication is possible. A patient can be given a picture of the health care professional along with contact information (e-mail address, phone number, etc.). Even a video chat is made possible using, for example, a proprietary third-party app communication system. This system allows immediate response to questions and guidance to appropriate care using triage protocols, education regarding appropriate use of urgent care versus an emergency room, and personal coaching and disease management based on disease state.

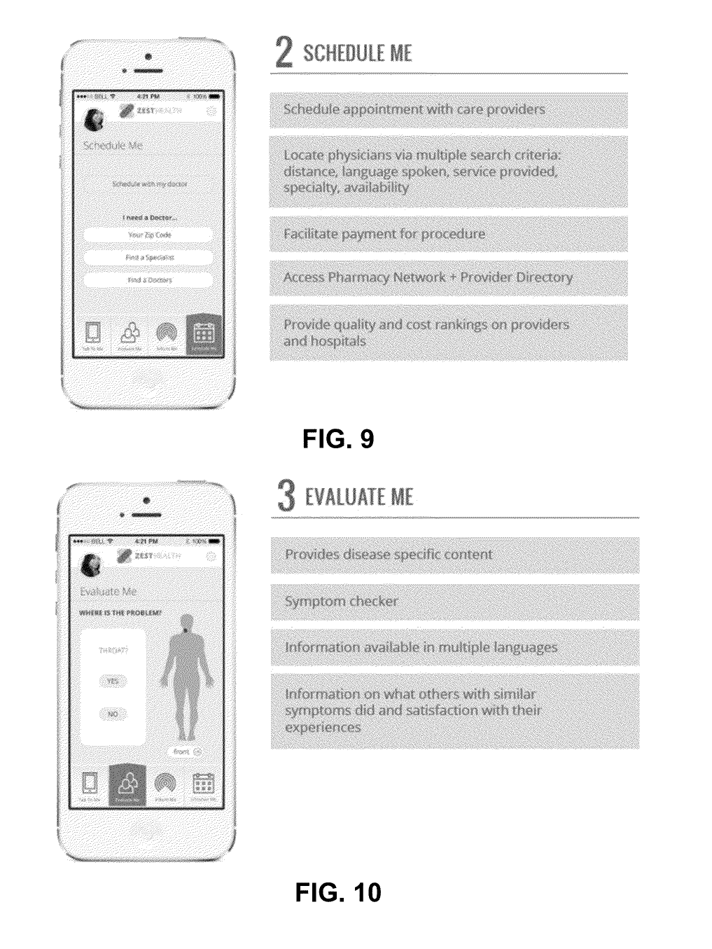

FIG. 9 is a screen shot of the second 302 of the four elements shown at FIG. 7 according to an embodiment of the present disclosure. In the “schedule me” tab 302, the system includes many of the famous calendar functions. By connecting to a database on the server (as for the other elements described herein), information is uploaded. Different indexing tools can be used, such as a localization function on the phone to help determine proximity, the entry of a zip code, or the different entry of specialties needed. The system allows the user to schedule appointments with care providers, locate physicians, facilitate payment for procedures, access pharmacy networks and different provider directories, and provide quality and cost rankings on providers and hospitals.

FIG. 10 is a screen shot of the third 303 of the four elements shown at FIG. 7 according to an embodiment of the present disclosure. With this tool, a user can help diagnose problems, diseases and conditions to maximize the use of the other functions. For example, a user, before talking with a nurse using the ‘talk to me’ function 301, can evaluate himself/herself. The interface can use multiple languages and will index different databases on the servers. As shown, content can be given. By using a body figure as shown, a user can request specific information in an area of concern. Symptoms can be checked and entered. The information can be available in multiple language and using online remote capacity, an online encyclopedia can be accessed.

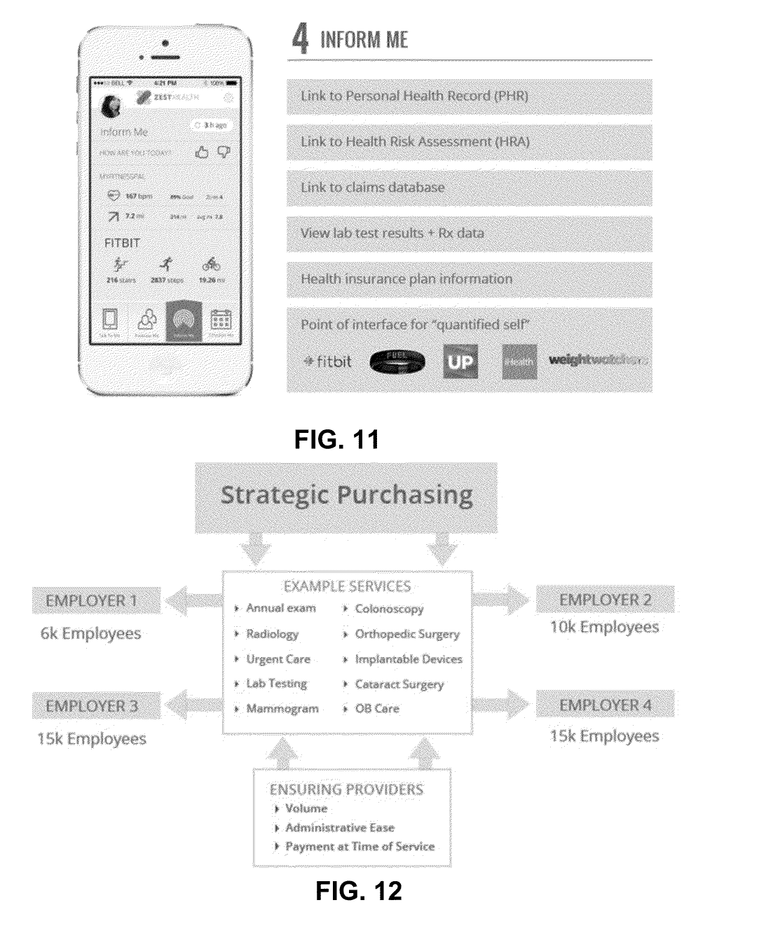

FIG. 11 is a screen shot of the fourth of the four elements 304 shown at FIG. 7 according to an embodiment of the present disclosure. The content of this tab may include many different types of medical-related sources and databases. A user can also include different third-party apps. For example, as shown the tab can include personal health records, a health risk assessment, links to claims databases of insurance companies, lab test results and other medical information, information about a health plan, and other tools such as Fitbit®, Nike Fuel®, etc.

FIG. 12 is a diagram representing the strategy purchasing method according to an embodiment of the present disclosure 500. By accessing a large volume of users over the health care services optimization platform as shown at FIGS. 1-11, many other advantages can be created. For example, strategic purchasing of services, goods or equipment used during services can be accomplished. For example, using volume, administrative ease and payment at the time of service (via a preapproval system with an insurance carrier) 501, the system can purchase and research expensive equipment on behalf of a health care facility. For example, a doctor in private practice who desires to buy five wheelchairs may not get a good price, but if a hundred doctors work in tandem to acquire the goods, a lower price can be secured from the service provider.

The same is true for multiple large employers with multiple employees. If each is asked to use the platform, then by aggregating the health care needs of all employees, lower costs can be achieved. For example, if 0.5% of patients require a mammogram each year, and the system has 50,000 users, the system can determine that it will need equipment and goods associated with 250 mammograms. As shown at 500, multiple employers 1, 2, 3, and 4 illustrated by 502, each will have a different number of employees who have needs to acquire and strategically purchase the goods and services.

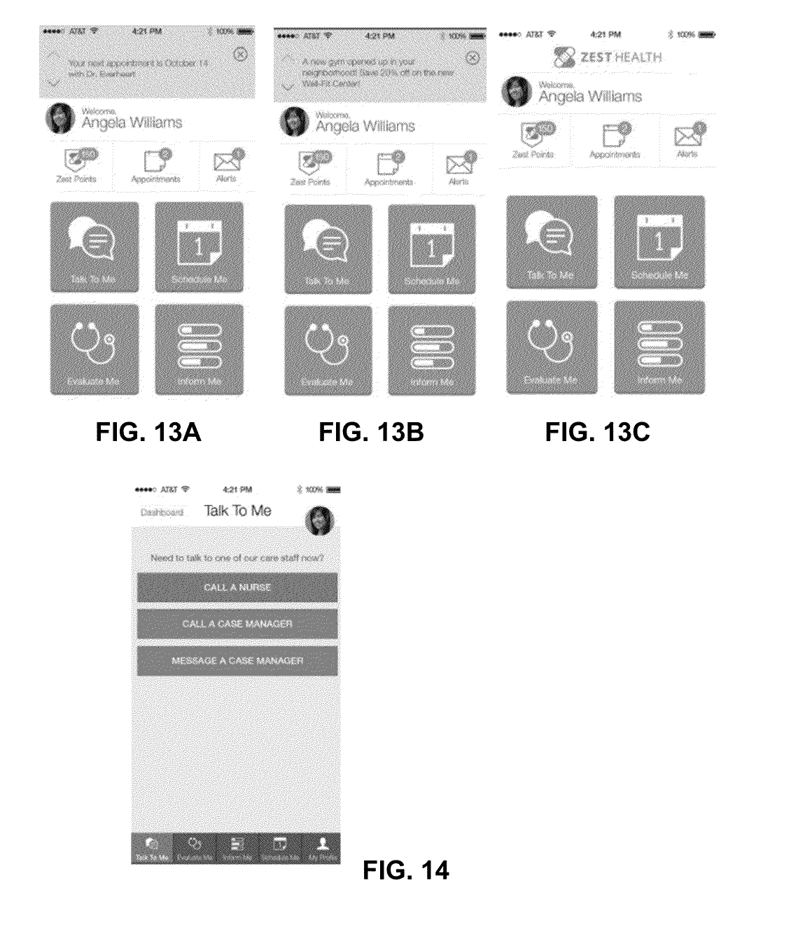

FIGS. 13A to 13C represent three different screen shots, taken from the App highlighting the concept that an advertising and notice area on top 610 of the display can be used as part of a software display according to an embodiment of the present disclosure. In FIG. 13A, the space above the user's profile is used to remind a user of the next appointment; in FIG. 13B the same space gives a user information to help improve health performance (here a gym is advertised along with a promotional code); and finally, at FIG. 13C, simple labeling is used as advertisement space. Also shown in these figures is a system whereby the app operating system is used to help (in red) provide live notices as for different points of interest. Here Ms. Williams 601 is reminded that she owns 150 award points 602, has two appointments 603 and one alert 604.

FIG. 14 is a screen shot of an app software display of the health care services optimization platform showing the “talk to me” 301 element according to an embodiment of the present disclosure. Three buttons are displayed to either contact a nurse 701, contact a case manager 702 or simply leave a message for a case manager 703. These different parties can be predefined in the user setup or can be selected by the home system database of the platform to help provide better and more related services. For example, the system may use a user's location as given by the GPS tracking function of the wireless phone to help locate a user. The system may assign a nurse in the proximity of the user who is on call and has an active status based on a database entry. As shown, the system may be programmed to connect the patient directly with the health care professional.

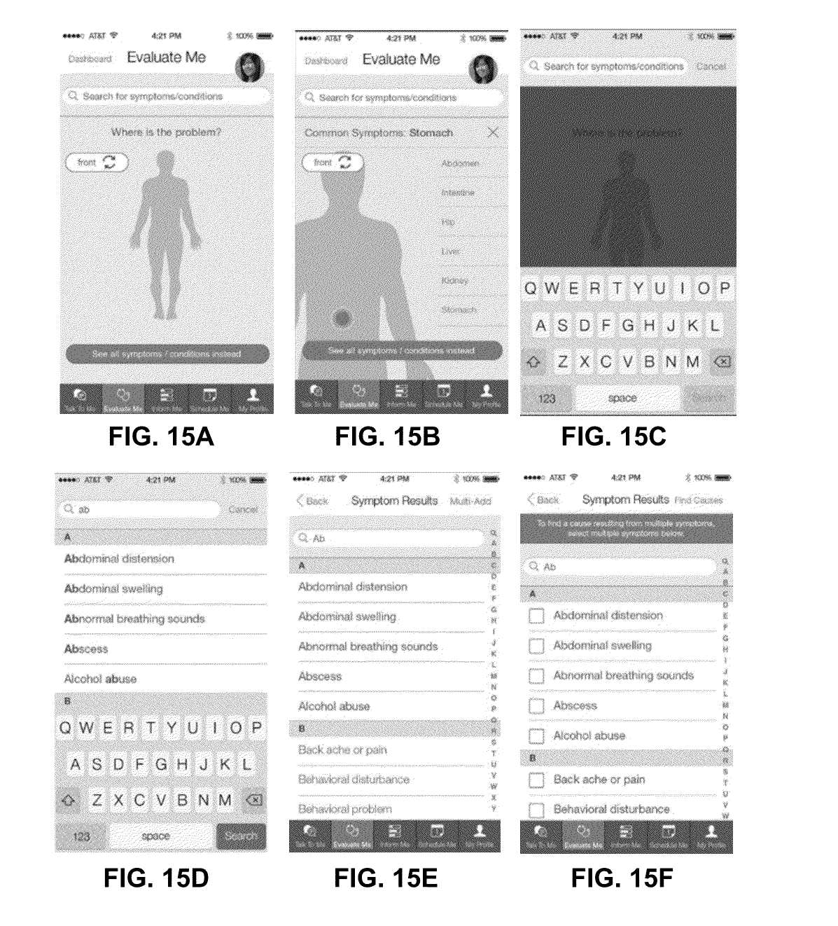

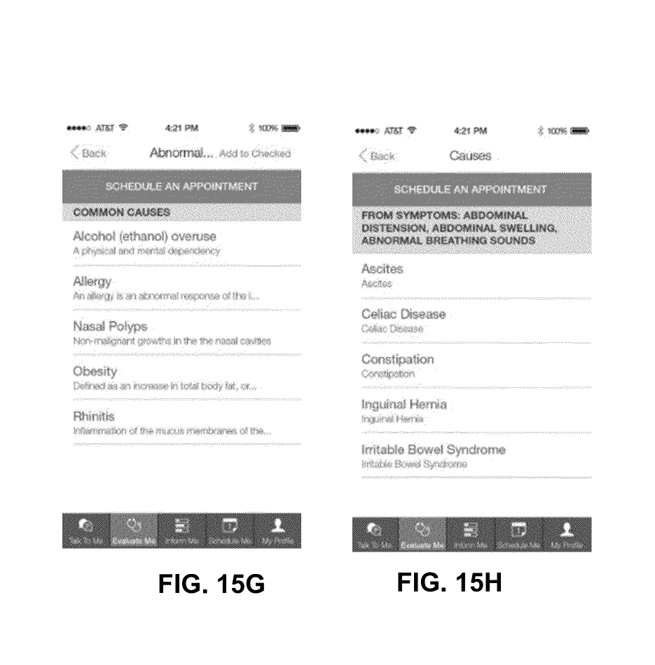

FIGS. 15A to 15H are multiple screen shots of an App software display of the health care services optimization platform showing the “evaluate me” 303 element according to an embodiment of the present disclosure. Part of the problem with medical communications is the lack of medical training of most users. Over the phone, much of the time is wasted by the health care professional asking the same routine questions to help define the applicable problem. While diagnosis is part of medical services, a user's understanding may be heightened to some extent to help facilitate the connection. Software helps offer users with information, but as can be expected, medical information can be very vast, varied, and misleading to the unskilled. For this reason, many medical experts ask patients not to self-diagnose. The current App allows for the system to offer some level of evaluation. The terminology asked by the doctor or the nurse is presented to the patient who can, using the software, lean how to best describe the condition.

By surfing multiple pages, using a simple interface, the patient/user will be able to anticipate the doctor's next questions and offer more constructive data. At FIG. 15A, a user is shown a human body (that of a child, a woman, or a man—not shown), and can be asked to simply touch a portion of a touch screen 801 to indicate which part of the body 802 has symptoms. A button can also rotate the figure to help the user find the right portion of the human form 803. In another way of searching, a search bar 804 allows a user to enter using a keyboard the condition.

In a subsequent step, after a portion of the body is touched 805, as shown at FIG. 15B, a scroll down to the needed condition in an alphabetical list of common symptoms can be offered associated with the location that was touched 806. A user can also type in 807 a symptom as shown at FIG. 15C. Because the name of medical conditions, even when typed by a user who knows generally the name of a condition, a pre-populated list from a database information as shown at FIG. 15D can be offered with the typed portion in bold 808 to help with indexing. At FIG. 15E, the symptoms can be grouped alphabetically or as shown at FIG. 15F, a simple click box can be used to help guide the selection.

While the platform may not be in a position to make a diagnosis, the information entered can be sent directly to the health care professional once a phone connection is established. The information can be used to list the most common causes 809 to help with the schedule of an appointment as shown at FIG. 15G. Often, a patient may have an idea of what type of problem causes the symptoms. As shown at FIG. 15G, a person will know if allergy is a possible suspect. FIG. 15H provides a different interface. One of ordinary skill in the art will understand that while the giving of conditions is possible, each app or interface may be programmed to control the release of information to the patient to prevent incorrect self-diagnosis.

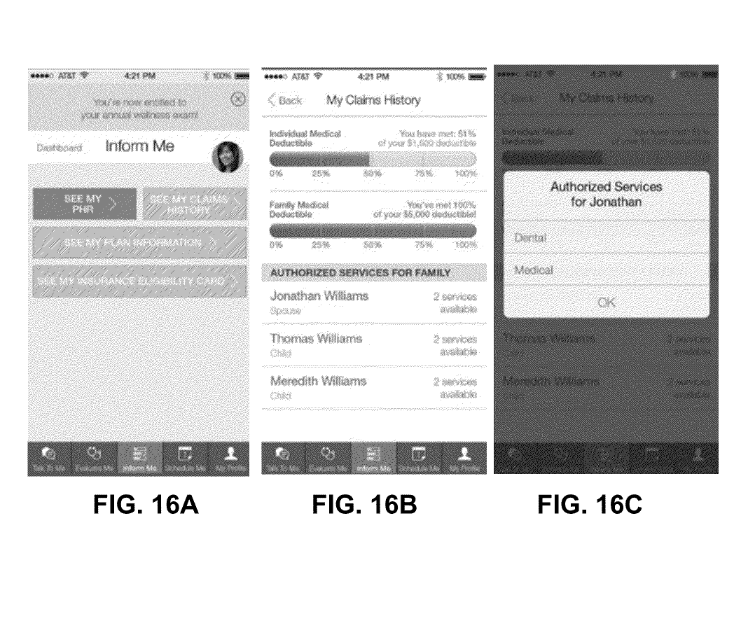

FIGS. 16A and 16B are multiple screen shots of an App software display of the health care services optimization platform showing the “inform me” 304 element according to an embodiment of the present disclosure. As shown, insurance plan information 901 can be entered either by the user or directly by the platform programmer to help a user understand the basic parameters of the plan. For example, plan information and insurance eligibility card information 902 can be accessed. A claim history 903 along with the medical deductible used can be listed along with the different people authorized for services as shown at FIG. 16B.

FIG. 16B allows a user to find out which services are available for a user or his/her dependents. Also, based on the condition entered or diagnosed, a user may obtain information about the costs and treatment options for the conditions, along with the prices for the same service in different health care facilities in the area. Data pertinent to the management of a medical deductible can be given 904. The information can be provided for one individual or for a family as a whole 905. The system can also list what services are available for family members 906.

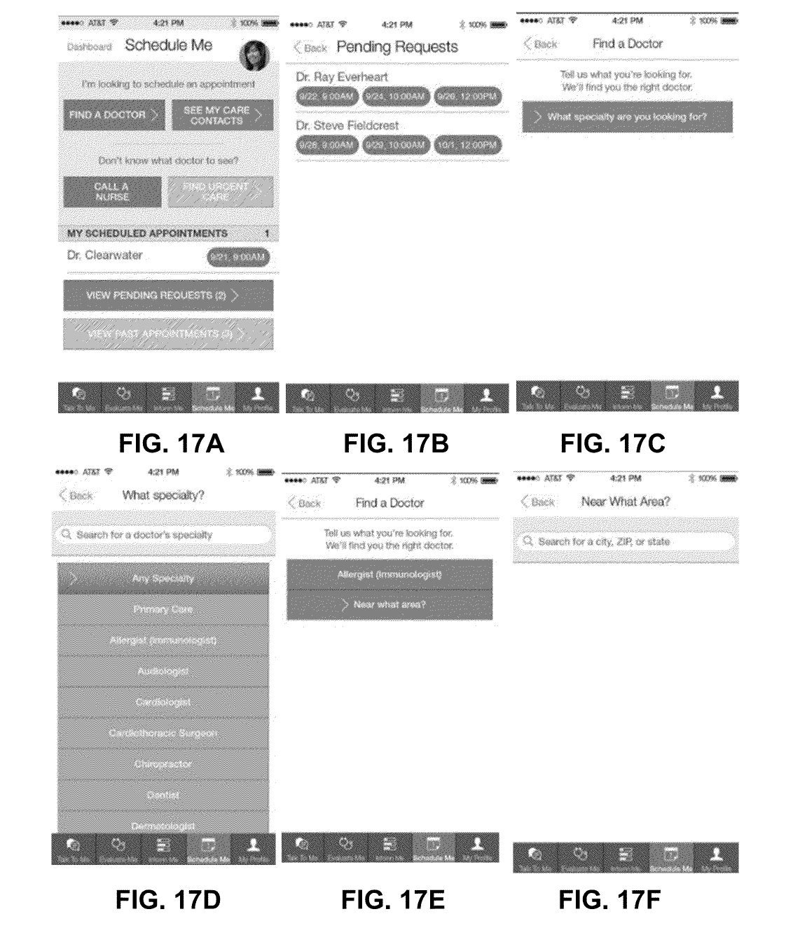

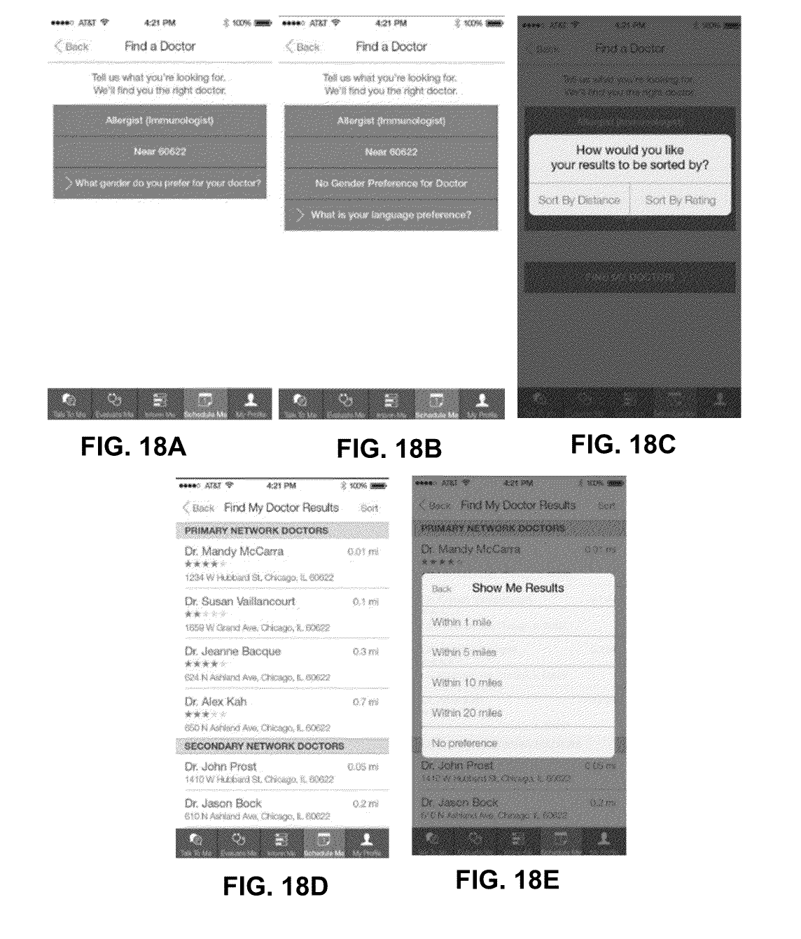

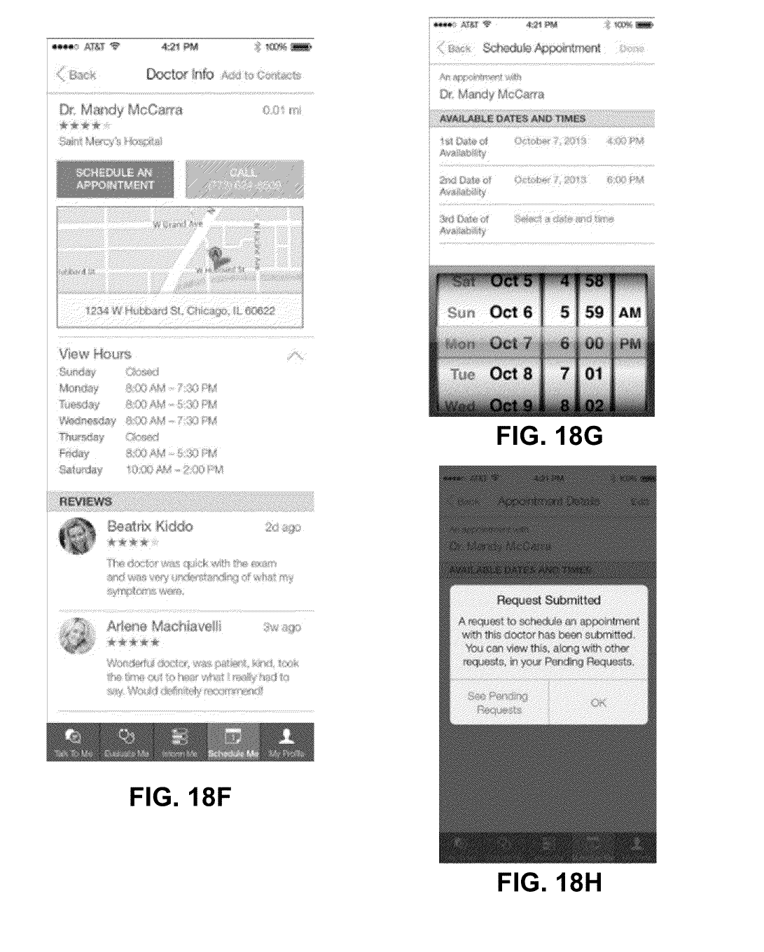

FIGS. 17A-17F and 18A-18H are multiple screen shots of an app software display of the health care services optimization platform showing the “schedule me” 302 element according to an embodiment of the present disclosure. Using multiple cross-indexed databases and external databases of different health care facilities and different doctors, the system will exchange data to allow a user can find a doctor 1001, see the care contacts 1002, call a nurse 1003 or find urgent care 1004 using the app as shown at FIG. 17A. In each case, the user will simply push the button on the user device and the system will pair up with one of these four databases.

FIG. 17B shows how an appointment as shown can either be already scheduled; there may be pending requests or where a party can have pending requests 1005. This principle is not unlike the principle of making restaurant reservations with some additional steps. The system can give a doctor information about a patient, transfer the data entered by the patient, and provide access to part or all of a patient's medical history. Also shown is how different times can be offered by a service provider to help a user select the best option possible.

FIG. 17C shows how the interface helps a user select a doctor. For example, a user as shown at FIG. 17D may be asked to select from a plurality of specialties, then at FIG. 17E the user then indexes the area where care is needed and as shown at FIG. 17F. This search tool can also be adapted based on the insurance plan of the user to allow him/her to select only doctors or physicians that fall within the policy. FIGS. 18A to 18H provide usual ways to help select a physician. As shown at FIG. 18F, doctors or primary physicians can be reviewed or analyzed by past patients. The result of this system is to force doctors and other service providers to offer better customer care.

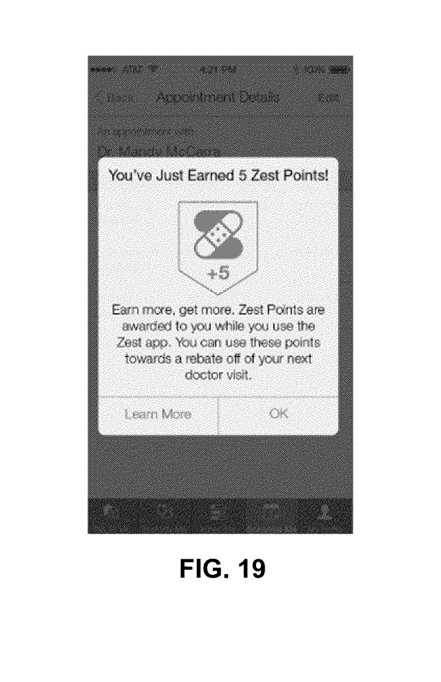

FIG. 19 is a screen shot of an app software display of the health care services optimization platform showing the reward points system according to an embodiment of the present disclosure. As part of using apps and other direct user interfaces, the use of marketing and reward and incentive programs is possible. In this case, users are given ‘points’ to help gain credits for further services.

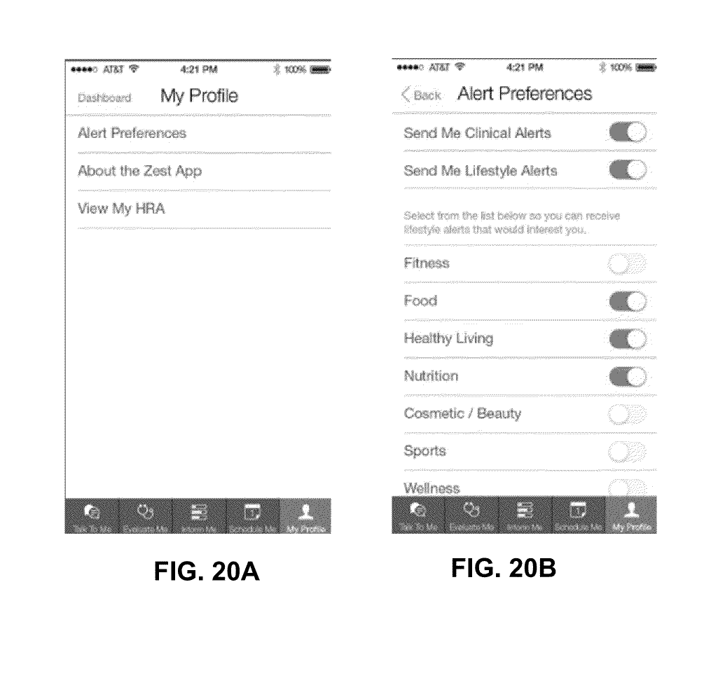

FIGS. 20A and 20B are multiple screen shots of an app software display of the health care services optimization platform showing the “my profile” element according to an embodiment of the present disclosure. These allow a user to set up alerts and preferences for each device used.

What is described in great detail and via the figures is a fully integrated system and platform where a patient, a user 5 as shown at FIG. 1 can interact with his or her doctor or nurse as part of the larger nebula of secondary actors like a health insurance 6 (either private 2, or governmental 3), a supply vendor 7 who offers different goods, a service facility 4 who either houses the doctor or nurse or acts as a large employment center.

The main tool as described is a hardware layer illustrated generally at FIGS. 2, 3, and 4 which houses multiple layers of software illustrated generally at FIGS. 5, to 18. One of ordinary care and skill will understand that while the current embodiment migrates away from a classical computer implement system to a system using cell phones as portable devices and where the software is localized in banks of software, currently sold in the APP format (generally called Apps sold in App stores), the current description also includes all other possible embodiments known in the art. In fact, what is contemplated is a combination of remote portable devices using Apps based tools, web browsing interfaces in HTML protocol, classical software mounted in servers and desk top computers, and tablets also generally in use. For example, a service provider, such as a hospital may decide to customize a software layer to better enable the present invention to operate.

What is describe in part is a health care services optimization platform 200, comprising a hardware layer shown at FIGS. 2-4 used to host and execute a software layer shown in part at FIGS. 5-18 therein, the platform 200 is designed when operating in conjunction with the functionalities of the software to help a patient/user 5 improved and optimize health care services. The platform 200 includes a hardware layer with least one remote server 102 connected to a network communication system 103 like the Internet where the remote server has a remote memory and a remote computer processor (shown 102 as a standalone cabinet) for executing therein a software layer also described as software which serves a purpose, and where the remote server 102 as shown at FIG. 3 stores 201 at least a user version of an App 202 and a service provider version of the App 203 for upload.

As shown at FIG. 2, a plurality of user devices 108 each with inner parts which include a local computer processor, a local memory and a user display shown for example as computer stations 104, 105 for allowing the plurality of users 107 on FIGS. 2 and 5 on FIG. 1, to access the software layer of the at least one remote server 102 via the network communication system 103 and to upload the user version of the App 202 stored in the remote memory of the remote server 102, and wherein each of the plurality of user devices 104, 105 is capable of executing the App in the local memory by the local processor and interact with the user of the user device via a user display (as shown) of the user device used by a user.

Also shown is how a plurality of service provider devices 104, 105 shown on FIG. 3 as 203 each with a provider computer processor, a provider memory and a provider display for allowing the plurality of service providers to access the software layer 208 of the at least one remote server 102, wherein each service provider device 104, 105 is capable of uploading via the network 103 over the software layer the service provider version of the App 203 stored in the remote memory of the remote server 102. In one embodiment, both the user and the provider uses cell phone technology and an App mounted in their respective devices.

The platform 200 also provides that each service provider device 104, 105, is capable of executing the service provider version of the App in the provider memory by the provider computer processor. For example, a doctor or a nurse can upload 203 the App from the App store 201 who will then be able to connected to the user (patient) devices 202. One of ordinary skill in the art will recognize that the software layer of the platform residing and executing in the hardware layer. For example operating systems known in the art residing within the remote memory, the local memory, and the provider memory are executable respectively by the remote computer processors, the local computer processor, and the provider computer processors, when executed allow for the communication and exchange of data between the plurality of user devices.

An software App storage and user interface for storing a plurality of Apps within the memory of the remote memory, for example an App store, for allowing an App retrieval and execution software to upload by the plurality of user devices like cell phones the user version of the App. The same can also be done by the plurality of service provider devices the service provider version of the App, wherein the user version of the App executes in the memory of the local memory by the local computer processor for direct interaction and exchange of data over the network communication system 103 with the service provider version of the App executing in the provider computer processor. The software App also can be designed to upload data over the communication network system 103 from external layers of data from databases as shown at 204, 205, and 206 at FIG. 3.

In one embodiment, both the service provider version of the App and the user version of the App can be the same software but once a user is defined either as a user or a service provider, different functions will be offered. As shown in the figures, the software layer from the perspective of the user is mostly shown. A doctor or service operator will see the mirror image of the different functions as shown. The doctor will see an agenda, will fill in times when he or she wants to be scheduled. Will set up if potential patients can automatically log him or her or the approval process must be done with each request.

The system operates in tandem (i.e. communication bridge between a user and provider) over the network communication network 103 to allow the user as a patient 5 to receive at the user display optimize health care services as shown at FIG. 7 with a means for performing a patient optimize health care service, the service including a software interface with a talk-to-me function 301, a schedule-me function 302, an evaluate-me function 303, and an inform-me function 304. As described above, these functions allow a user, normally a patient to expedite several key aspects of health care related services by informing the client, coordinating the communication between the client and a service expert, by setting up the calendar and by helping the patient get a better grasp of his or her condition.

As shown with greater detail at FIG. 8, the talk-to-me function 301 is a means for communication between at least a user 5 and a service provider 4 and includes a primary assigned medical service provider 401 for contact over a phone line, email, or video conference, and a secondary medical service provider 402 for contact over a phone line, email, or video conference. This process is easy to understand. For example, if a patient falls and hurts himself during a bike ride, the person might first use a user device to call 911 and get the emergency contact on their way. In addition to performing normally scheduled meetings, the user can simply push to talk to the doctor 401 or the nurse 402 of his or her preference to help get help as the ambulance arrives. As shown, these people can be selected from a group consisting of a doctor, a nurse, and a case manager.

As shown at FIG. 9, the schedule-me function 302 is a software interface which includes the function of entry of a zip code, a choice between scheduling a doctor, a care contact, a nurse, or urgent care, and wherein the function of entry of a doctor includes the entry of a specialty, the gender of the service provider, and a language preference. FIG. 17 is helpful to understand this function with greater clarity.

As shown at FIG. 17B, the function of entry of a doctor includes the entry of available dates and times, a selection of a pre-selected doctor after the geographical data of a doctor's location and a third party review of the doctor. The schedule-me function 302 also can include a graphical human body interface to select a zone of interest of a medical problem, a choice of common symptoms, and a tool to index different symptom results. It can also include a selection for claims history, includes information about a medical deductible, and a family deductible based on the policy, a selection to see plan information, a selection to see an insurance eligibility card.

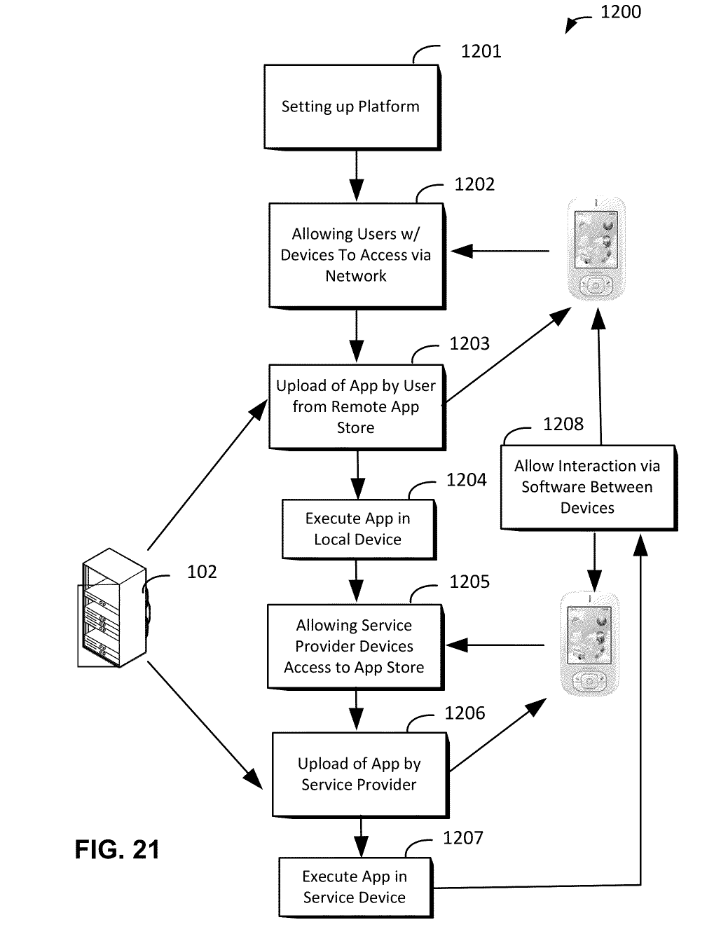

FIG. 21 shows a method 1200 for providing optimized health care services over a health care services optimization platform, on a platform set-up as defined above 1201 upon which the method is performed, the method comprising the steps of allowing 1202 a plurality of users, each using one of the plurality of user devices to access the software layer of the at least one remote server via the network communication system, uploading 1203 by each of the plurality of users, within the local memory of the user device the user version of the App stored in the remote memory of the remote server, executing 1204 in the local computer processor the user version of the App, allowing 1205 a plurality of service providers, each using one of the plurality of service provider devices to access the software layer of the at least one remote server via the remote network communication system, uploading 1206 by each of the plurality of service providers, within the provider memory of the service provider devices the provider version of the App stored in the remote memory of the remote server, executing 1207 the user version of the App, and allowing 1208 the user to interact with the service provider as shown by lines via the platform by using at the App interface on the user display a combination of a talk-to-me function 1301, a schedule-me function 1302, an evaluate-me function 1303, or an inform-me function 1304.

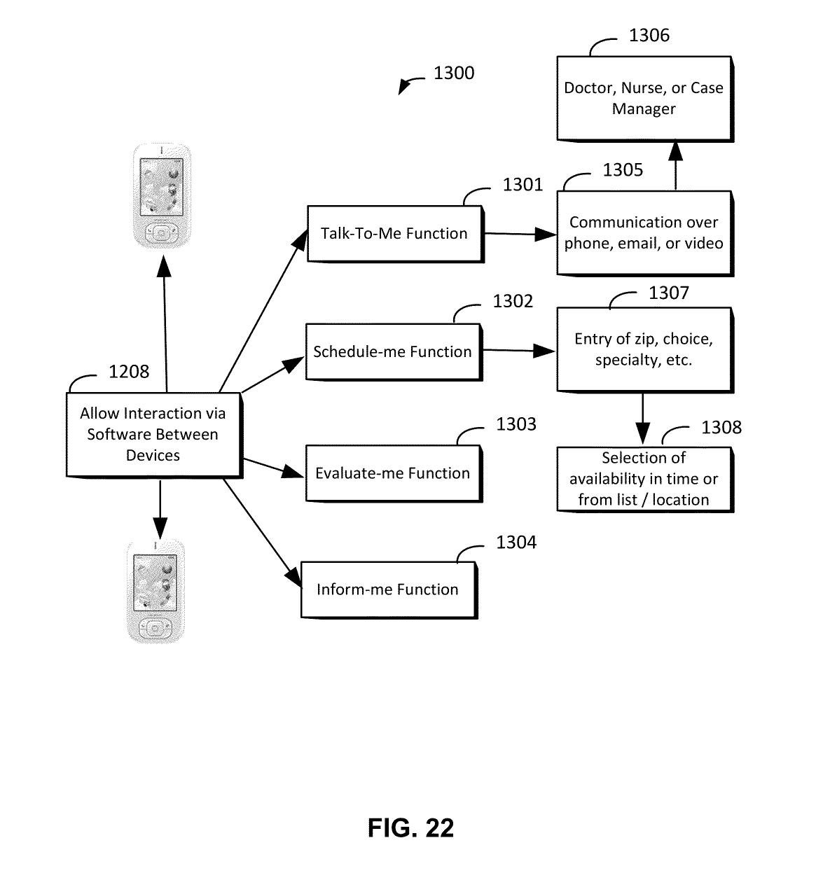

The step of user interaction with the talk-to-me function 1301 as shown at FIG. 22, includes the step of communication 1305 between at least a user and a service provider and includes a primary assigned medical service provider for contact over a phone line, email, or video conference, and a secondary medical service provider for contact over a phone line, email, or video conference and a person from a group consisting 1306 of a doctor, a nurse, and a case manager.

In another embodiment, the step 1302 includes 1307 of entry of a zip code, a choice between scheduling a doctor, a care contact, a nurse, or urgent care, and further includes the step of entry of a specialty, the gender of the service provider, and a language preference. As shown, the step of selection of a doctor 1307 can includes the step 1308 of selecting one available date and time from a list of available dates and times, selecting one doctor from a pre-selected group of doctor offered to the user based on a geographical data of a doctor's location, a doctor includes the steps of selecting one doctor from a pre-selected group of doctor offered to the user based on a geographical data of a doctor's location.

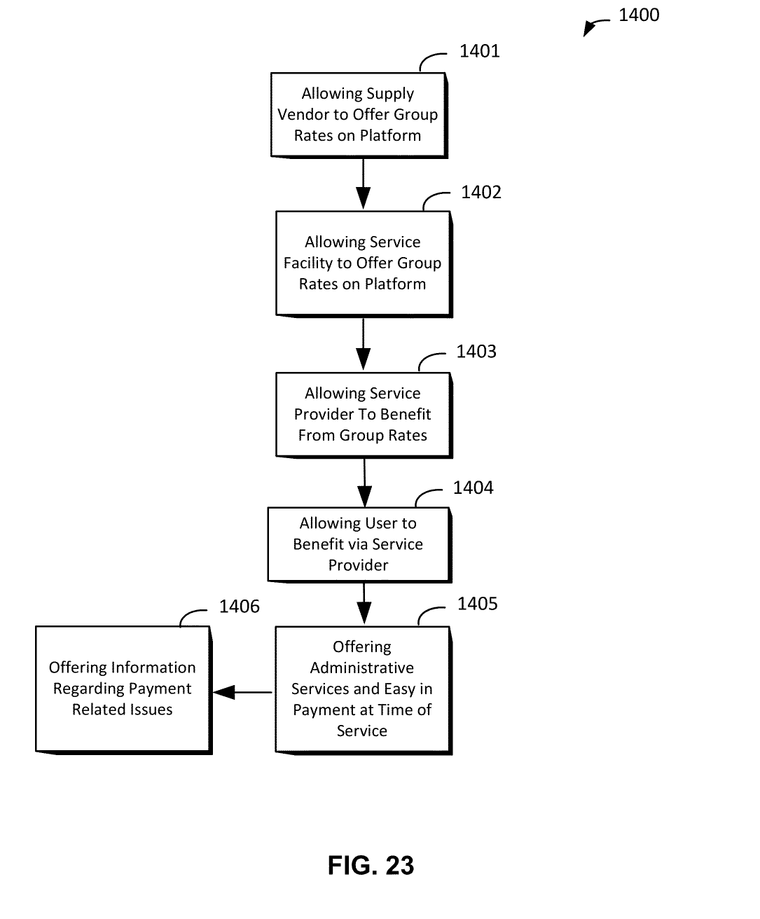

Finally, FIG. 23 is directed to a method for allowing strategic purchasing 1400 from supply vendors by a service facility using an optimized health care services optimization platform, the service including allowing 1401 at least a supply vendor to offer group rates for the supply of medical related goods, allowing 1402 at least a service facility to offer group rates for the supply of medical related services, allowing 1403 at least one service provider to benefit from the group rates for the supply of medical related goods or the medical related services as part of its own services and offer the group rates to the user, and allowing 1404 a user to access the service provider and benefit from the group rates offered. In another embodiment, the method 1400 includes the step of offering 1405 to the service provider an additional benefit by offering administrative services and ease in payment at the time of service or the step 1406 of offering information to the user regarding payment related issues, including data relating to past spending on deductible costs.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A health care services optimization platform, comprising a hardware layer used to host and execute a software layer therein, the platform designed when operating in conjunction with the functionalities of the software to help a patient optimize health care services,
(a) the hardware layer of the platform comprising:
at least one remote server connected to a network communication system with a remote memory and a remote computer processor for executing therein a software layer and for storing at least a user version of an App and a service provider version of the App for upload;
a plurality of user devices each with a local computer processor, a local memory and a user display for allowing the plurality of users to access the software layer of the at least one remote server via the network communication system and to upload the user version of the App stored in the remote memory of the remote server, and wherein each of the plurality of user devices is capable of executing the App in the local memory by the local processor and interact with the user of the user device via a user display of the user device used by a user; and
a plurality of service provider devices each with a provider computer processor, a provider memory and a provider display for allowing the plurality of service providers to access the software layer of the at least one remote server, wherein each service provider device is capable of uploading via the network over the software layer the service provider version of the App stored in the remote memory of the remote server, and wherein each service provider device is capable of executing the service provider version of the App in the provider memory by the provider computer processor;
(b) the software layer of the platform residing and executing in the hardware layer comprising:
one layer of operating systems residing within the remote memory, the local memory, and the provider memory executable respectively by the remote computer processors, the local computer processor, and the provider computer processors, when executed allow for the communication and exchange of data between the plurality of user devices, the plurality of service provider devices and the remote server via the network communication system; and
a software App storage and user interface for storing a plurality of Apps within the memory of the remote memory, for allowing an App retrieval and execution software to upload by the plurality of user devices the user version of the App, and upload by the plurality of service provider devices the service provider version of the App, wherein the user version of the App executes in the memory of the local memory by the local computer processor for direct interaction and exchange of data over the network communication system with the service provider version of the App executing in the provider computer processor, and wherein the App also uploads data over the communication network system from external layers of data from databases; and
(c) the service provider version of the App and the user version of the App operating in tandem over the network communication network to allow the user as a patient to receive at the user display optimize health care services with a means for performing a patient optimize health care service, the service including a software interface with a talk-to-me function, a schedule-me function, an evaluate-me function, and an inform-me function.

2. The health care services optimization platform of claim 1, wherein the talk-to-me function is a means for communication between at least a user and a service provider and includes a primary assigned medical service provider for contact over a phone line, email, or video conference, and a secondary medical service provider for contact over a phone line, email, or video conference.

3. The health care services optimization platform of claim 2, wherein the primary assigned medical service provider and the secondary medical service provider are both selected from a group consisting of a doctor, a nurse, and a case manager.

4. The health care services optimization platform of claim 1, wherein the schedule-me function is a software interface includes the function of entry of a zip code, a choice between scheduling a doctor, a care contact, a nurse, or urgent care, and wherein the function of entry of a doctor includes the entry of a specialty, the gender of the service provider, and a language preference.

5. The health care services optimization platform of claim 4, wherein the function of entry of a doctor includes the entry of available dates and times, a selection of a pre-selected doctor after the geographical data of a doctor's location and a third party review of the doctor.

6. The health care services optimization platform of claim 1, wherein the schedule-me function includes a graphical human body interface to select a zone of interest of a medical problem, a choice of common symptoms, and a tool to index different symptom results.

7. The health care services optimization platform of claim 1, wherein the inform-me function includes a selection for claims history, a selection to see plan information, a selection to see an insurance eligibility card.

8. The health care services optimization platform of claim 7, wherein the selection of claims history includes information about a medical deductible, and a family deductible based on the policy.

9. A method for providing optimized health care services over a health care services optimization platform, the platform upon which the method is performed comprising a hardware layer with at least one remote server connected to a network communication system with a remote memory and a remote computer processor for executing therein a software layer and for storing at least a user version of an App and a service provider version of the App for upload, a plurality of user devices each with a local computer processor, a local memory and a user display, a plurality of service provider devices each with a provider computer processor, a provider memory and a provider display for allowing the plurality of service providers to access the software layer of the at least one remote server, the software layer of the platform residing and executing in the hardware layer comprising one layer of operating systems residing within the remote memory, the local memory, and the provider memory executable respectively by the remote computer processors, the local computer processor, and the provider computer processors, when executed allow for the communication and exchange of data between the plurality of user devices, the plurality of service provider devices and the remote server via the network communication system, and a software App storage and user interface for storing a plurality of Apps within the memory of the remote memory, and the service provider version of the App and the user version of the App operating in tandem over the network communication network to allow the user as a patient to receive at the user display optimize health care services with a means for performing a patient optimize health care service, the service including a software interface with a talk-to-me function, a schedule-me function, an evaluate-me function, and an inform-me function, the method comprising the steps of:
allowing a plurality of users, each using one of the plurality of user devices to access the software layer of the at least one remote server via the network communication system;
uploading by each of the plurality of users, within the local memory of the user device the user version of the App stored in the remote memory of the remote server;
executing in the local computer processor the user version of the App;
allowing a plurality of service providers, each using one of the plurality of service provider devices to access the software layer of the at least one remote server via the remote network communication system;
uploading by each of the plurality of service providers, within the provider memory of the service provider devices the provider version of the App stored in the remote memory of the remote server;
executing the user version of the App; and
allowing the user to interact with the service provider via the platform by using at the App interface on the user display a combination of a talk-to-me function, a schedule me function, or an evaluate-me function, or an inform-me function.

10. The method for providing optimized health care services over a health care services optimization platform of claim 9, wherein the step of user interaction with the talk-to-me function includes the step of communication between at least a user and a service provider and includes a primary assigned medical service provider for contact over a phone line, email, or video conference, and a secondary medical service provider for contact over a phone line, email, or video conference.

11. The method for providing optimized health care services over a health care services optimization platform of claim 10, wherein the step of user interaction with the talk-to-me function includes the step of communication with the primary assigned medical service provider and the secondary medical service provider includes the step of communication with a person from a group consisting of a doctor, a nurse, and a case manager.

12. The method for providing optimized health care services over a health care services optimization platform of claim 9, wherein step of user interaction with the schedule-me function includes the step of entry of a zip code, a choice between scheduling a doctor, a care contact, a nurse, or urgent care, and further includes the step of entry of a specialty, the gender of the service provider, and a language preference.

13. The method for providing optimized health care services over a health care services optimization platform of claim 12, wherein the step of selection of a doctor includes the steps of selecting one available date and time from a list of available dates and times.

14. The method for providing optimized health care services over a health care services optimization platform of claim 12, wherein the step of selection of a doctor includes the steps of selecting one doctor from a pre-selected group of doctor offered to the user based on a geographical data of a doctor's location.

15. The method for providing optimized health care services over a health care services optimization platform of claim 12, wherein the step of selection of a doctor includes the steps of selecting one doctor from a pre-selected group of doctor offered to the user based on a geographical data of a doctor's location.

16. A method for allowing strategic purchasing from supply vendors by a service facility using an optimized health care services optimization platform, the platform upon which the method is performed comprising a hardware layer with at least one remote server connected to a network communication system with a remote memory and a remote computer processor for executing therein a software layer and for storing at least a user version of an App and a service provider version of the App for upload, a plurality of user devices each with a local computer processor, a local memory and a user display, a plurality of service provider devices each with a provider computer processor, a provider memory and a provider display for allowing the plurality of service providers to access the software layer of the at least one remote server, the software layer of the platform residing and executing in the hardware layer comprising one layer of operating systems residing within the remote memory, the local memory, and the provider memory executable respectively by the remote computer processors, the local computer processor, and the provider computer processors, when executed allow for the communication and exchange of data between the plurality of user devices, the plurality of service provider devices and the remote server via the network communication system, and a software App storage and user interface for storing a plurality of Apps within the memory of the remote memory, and the service provider version of the App and the user version of the App operating in tandem over the network communication network to allow the user as a patient to receive at the user display optimize health care services with a means for performing a patient optimize health care service, the service including:
allowing at least a supply vendor to offer group rates for the supply of medical related goods;
allowing at least a service facility to offer group rates for the supply of medical related services;
allowing at least one service provider to benefit from the group rates for the supply of medical related goods or the medical related services as part of its own services and offer the group rates to the user; and
allowing a user to access the service provider and benefit from the group rates offered.

16. The method for allowing strategic purchasing from supply vendors by a service facility using an optimized health care services optimization platform of claim 15, wherein the service provider is a large scale employer with many employees.

17. The method for allowing strategic purchasing from supply vendors by a service facility using an optimized health care services optimization platform of claim 15, wherein the method further includes the steps of offering to the service provider an additional benefit by offering administrative services and ease in payment at the time of service.

18. The method for allowing strategic purchasing from supply vendors by a service facility using an optimized health care services optimization platform of claim 15, wherein the method further includes the step of offering information to the user regarding payment related issues, including data relating to past spending on deductible costs.
